(19) United States
(12) Patent Application Publication
(10) Pub. No.: US 2025/0168610 A1
(43) Pub. Date: May 22, 2025

(54) CONTROL METHOD, ELECTRONIC DEVICE, AND STORAGE MEDIUM

(71) Applicant: GUANGDONG OPPO MOBILE TELECOMMUNICATIONS CORP., LTD., Dongguan, Guangdong (CN)

(72) Inventor: Yifan ZHANG, Dongguan, Guangdong (CN)

(73) Assignee: GUANGDONG OPPO MOBILE TELECOMMUNICATIONS CORP., LTD., Dongguan, Guangdong (CN)

(21) Appl. No.: 18/871,103

(22) PCT Filed: May 23, 2022
(86) PCT No.: PCT/CN2022/094461

§ 371 Date: Dec. 2, 2024

(30) Foreign Application Priority Data
Jun. 15, 2021 (CN) 202110661501.4

(51) Int. Cl. H04W 4/80

(52) U.S. Cl. CPC H04W 4/80

(57) ABSTRACT

A control method, an electronic device, and a storage medium are provided. The control method is applied to a wearable device, the wearable device includes a first processor and a second processor, the first processor is configured to run a first system, the second processor is configured to run a second system, and the method includes: in response to a Bluetooth activation command, in a first state, the first system activates a first Bluetooth application, the first Bluetooth application supports a first service, and the second system activates a second Bluetooth application, the second Bluetooth application supports a second service; in a second state, the first system activates the first Bluetooth application, and the first Bluetooth application supports the first service, or, in the second state, the second system activates a third Bluetooth application, the third Bluetooth application supports the first service and the second service.

### CROSS REFERENCE TO RELATED APPLICATIONS

This application is a 35 U.S.C. § 371 National Phase conversion of the International Patent Application No. PCT/CN2022/094461, filed on May 23, 2022, claims priority to Chinese Patent Application No. 202110661501.4, filed Jun. 15, 2021, the disclosures of which are herein incorporated by reference in their entireties.

### TECHNICAL FIELD

The present disclosure relates to the field of Bluetooth technologies, and in particular to a control method, an electronic device and a storage medium.

### BACKGROUND

Currently, with the rapid development of the wearable technologies, wearable devices integrate more and more powerful functions. For example, wearable devices may integrate Bluetooth functionality, thereby enabling Bluetooth communication with mobile terminals. The wearable device includes a single processor. The single processor may for example be a high-performance central processing unit (CPU) or a micro controller unit (MCU). The high-performance CPU may support a large number of Bluetooth services that require higher processing performance, but its power consumption is relatively higher. The MCU may only support some Bluetooth services that do not require high processing capability, and its power consumption is relatively low. The existing wearable devices are unable to provide the Bluetooth functionality that balances between high performance and low power consumption according to actual situations.

### SUMMARY

In view of the above, the present disclosure intends to provide a control method, an electronic device, and a storage medium.

According to a first aspect, a control method performed by a wearable device is provided. The wearable device includes a first system and a second system. The method includes: in response to a Bluetooth activation instruction, in a first state, activating, by the first system, a first Bluetooth application, the first Bluetooth application being configured to support the first service; activating, by the second system, a second Bluetooth application, the second Bluetooth application being configured to support a second service; and/or in a second state, activating, by the first system, the first Bluetooth application, the first Bluetooth application being configured to support the first service; or, in the second state, activating, by the second system, a third Bluetooth application, the third Bluetooth application being configured to support the first service and the second service.

According to a second aspect, an electronic device, including a processor and a memory, is provided. The electronic device includes a first system and a second system. The memory is configured to store a computer program that is capable of running on the processor. The processor is configured to, while running the computer program, implement the operations of a control method. The method includes: in response to a Bluetooth activation instruction, in a first state, activating, by the first system, a first Bluetooth application, the first Bluetooth application being configured to support the first service; activating, by the second system, a second Bluetooth application, the second Bluetooth application being configured to support a second service; and/or in a second state, activating, by the first system, the first Bluetooth application, the first Bluetooth application being configured to support the first service; or, in the second state, activating, by the second system, a third Bluetooth application, the third Bluetooth application being configured to support the first service and the second service.

According to a third aspect, a computer-readable storage medium storing a computer program is provided. The computer program, when being executed by a processor of a wearable device, is configured to implement operations of a control method. The wearable device includes a first system and a second system. The method includes: in response to a Bluetooth activation instruction, in a first state, activating, by the first system, a first Bluetooth application, the first Bluetooth application being configured to support the first service; activating, by the second system, a second Bluetooth application, the second Bluetooth application being configured to support a second service; and/or in a second state, activating, by the first system, the first Bluetooth application, the first Bluetooth application being configured to support the first service; or, in the second state, activating, by the second system, a third Bluetooth application, the third Bluetooth application being configured to support the first service and the second service.

### BRIEF DESCRIPTION OF THE DRAWINGS

FIG. 1 is a schematic diagram of a Bluetooth scheme in the related art.

FIG. 2 is a schematic diagram of another Bluetooth scheme in the related art.

FIG. 3a is a schematic diagram of a system architecture where a control method according to an embodiment of the present disclosure is applied.

FIG. 3b is a schematic diagram of another system architecture where a control method according to an embodiment of the present disclosure is applied.

FIG. 4 is a schematic implementing flowchart of a control method according to an embodiment of the present disclosure.

FIG. 5 is a first schematic flowchart of a specific implementation of a control method according to an embodiment of the present disclosure.

FIG. 6 is a schematic diagram of a connection structure for a first processor and a second processor according to an embodiment of the present disclosure.

FIG. 7 is a schematic diagram illustrating how a wearable device implements a first Bluetooth application function according to an embodiment of the present disclosure.

FIG. 8 is a schematic diagram illustrating how a wearable device implements a second Bluetooth application function according to an embodiment of the present disclosure.

FIG. 9 is a second schematic flowchart of a specific implementation of a control method according to an embodiment of the present disclosure.

FIG. 10 is a third schematic flowchart of a specific implementation of a control method according to an embodiment of the present disclosure.

FIG. 11 is a schematic diagram of a display interface of a wearable device displaying an operation mode according to an embodiment of the present disclosure.

FIG. 12 is an implementing flowchart of a wearable device sending and receiving Bluetooth data according to an embodiment of the present disclosure.

FIG. 13 is a schematic diagram of a compositional structure of a control apparatus according to an embodiment of the present disclosure.

FIG. 14 is a schematic diagram of a compositional structure of an electronic device according to an embodiment of the present disclosure.

### DETAILED DESCRIPTION

Before the technical schemes of the present disclosure are described in detail, the related technologies are first introduced and described.

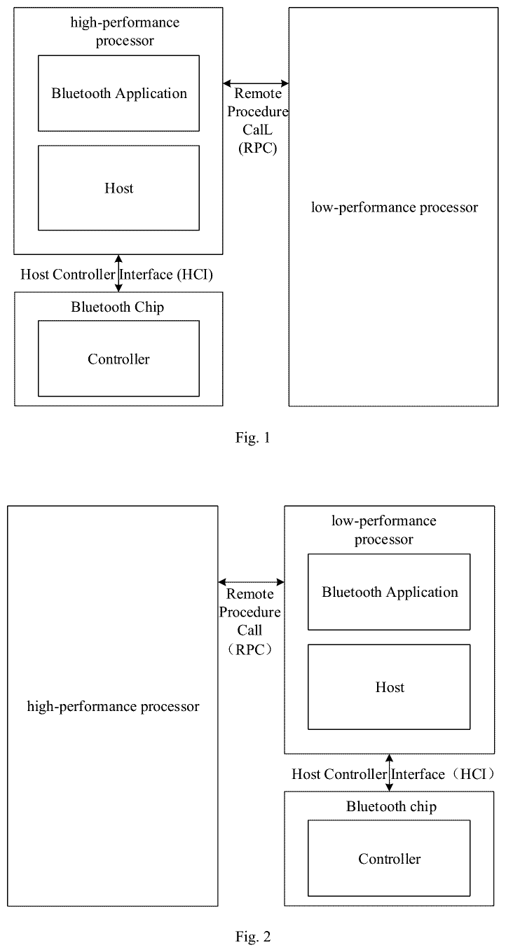

In the related technologies, in a dual-core system architecture supported by a mainstream wearable device, there is a division between a high-performance processor (such as a Qualcomm Snapdragon processor) and a low-performance processor (such as an MCU processor). The high-performance processor is configured to run an Android system, while the low-performance processor is configured to run a real-time operating system (RTOS). In existing dual-core systems, there are two kinds of Bluetooth schemes, namely a first scheme and a second scheme. In the first scheme, as illustrated in FIG. 1, a Bluetooth chip is mounted on or integrated with the high-performance processor, and a Bluetooth application runs on the high-performance processor, so as to provide a high-performance user experience. In the second scheme, as illustrated in FIG. 2, the Bluetooth chip is mounted on or integrated with the low-performance processor, and the Bluetooth application runs on the low-performance processor, so as to provide a low power-consumption user experience. However, the high performance and the low power consumption cannot be achieved simultaneously.

In summary, for the first scheme, the Bluetooth chip is mounted on the high-performance processor, a high-performance characteristic of the high-performance processor may be fully utilized, but an increased power consumption follows. In scenarios such as receiving message notifications from a cell phone, energy efficiency is prioritized over the performance. For the second scheme, the Bluetooth chip is mounted on the low-performance processor, a low power-consumption characteristic of the processor may be fully utilized, but performance is relatively poor. In scenarios such as App downloading or over the air technology (OTA) upgrades, the performance of the low-performance processor seems to be too low. In the existing dual-core devices, it is not possible to simultaneously utilize the high-performance characteristic of the high-performance processor and the low power-consumption characteristic of the low-performance processor. Only one of the high-performance characteristic of the high-performance processor and the low power-consumption characteristic of the low-performance processor may be selected, thereby leading to resource waste.

Based on the above, in various embodiments of the present disclosure, the wearable device includes a first processor and a second processor. The first processor is configured to run a first system. The second processor is configured to run a second system. In response to a Bluetooth activation instruction: in a first state, activating, by the first system, a first Bluetooth application, the first Bluetooth application being configured to support a first service, and activating, by the second system, a second Bluetooth application, the second Bluetooth application being configured to support a second service; and/or in a second state, activating, by the first system, the first Bluetooth application, the first Bluetooth application being configured to support the first service; alternatively, in the second state, activating, by the second system, a third Bluetooth application, the third Bluetooth application being configured to support the first service and the second service.

The following provides a more detailed description of the present disclosure in conjunction with the accompanying drawings and specific embodiments.

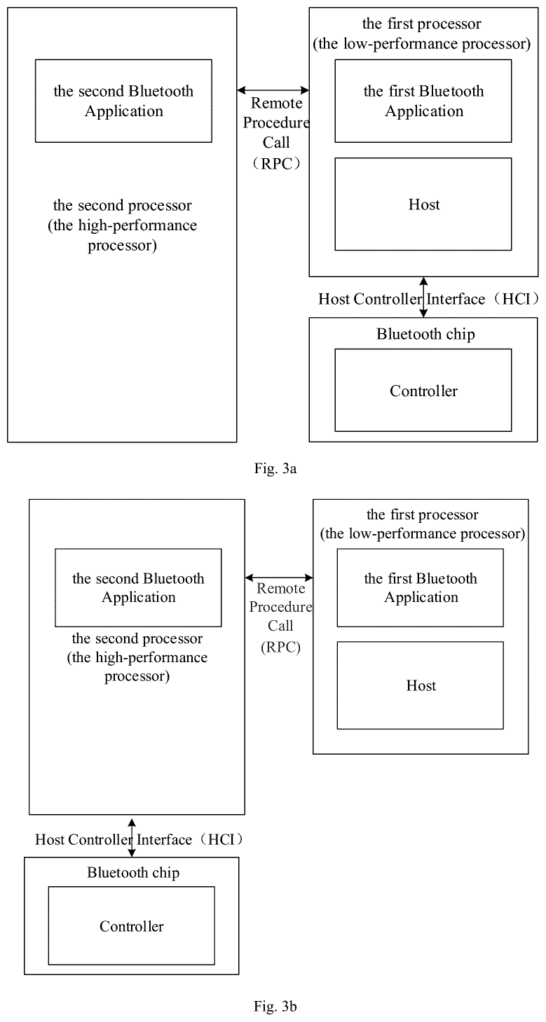

An example is illustrated in which the Bluetooth chip is mounted on the low-performance processor. FIG. 3a is a schematic diagram of a system architecture where a control method according to an embodiment of the present disclosure is applied. As illustrated in FIG. 3a, the system includes: the Bluetooth chip, the first processor and the second processor. The Bluetooth chip is mounted on or integrated with the first processor. The first processor is configured to run the first system. The second processor is configured to run the second system.

The first processor may refer to the low-performance processor, i.e., a microcontroller with a relatively low-level chip and supporting simple functions. The advantage of the first processor is that it consumes very little power and serves to enhance a battery life. The second processor may refer to the high-performance processor. i.e., the second processor includes a more advanced chip, more extensive function modules, and stronger processing capability. The second processor is aimed at enhancing functionality.

In other words, a performance level requirement of the second processor is higher than that of the first processor, and a power-consumption level requirement of the first processor is greater than that of the second processor.

An example is illustrated in which the Bluetooth chip is mounted on or integrated with the high-performance processor. FIG. 3b is a schematic diagram of another system architecture where a control method according to an embodiment of the present disclosure is applied. As illustrated in FIG. 3b, the system includes: the Bluetooth chip, the first processor and the second processor. The Bluetooth chip is mounted on or integrated with the second processor. The first processor is configured to run the first system. The second processor is configured to run the second system.

A wearable device adopts a dual-system architecture, which is a hardware architecture based on two processor chips. Each processor is configured to run a separate operating system. The two systems interact with each other to fulfill the Bluetooth functionality of the wearable device.

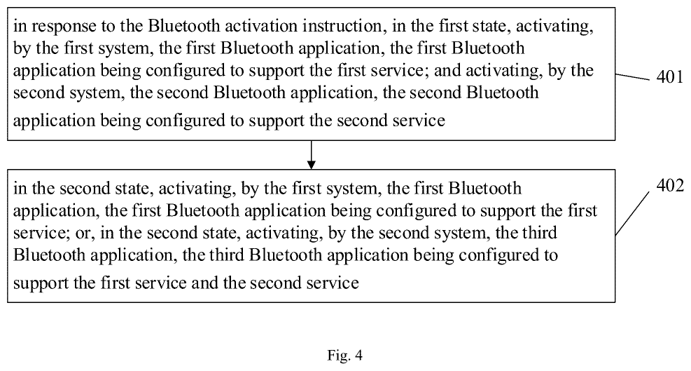

FIG. 4 is a schematic implementing flowchart of a control method according to an embodiment of the present disclosure. The control method may be performed by the wearable device. The wearable device includes the first processor and the second processor. The first processor is configured to run the first system. The second processor is configured to run the second system. The method includes operations at block 401 to block 402 as illustrated in FIG. 4.

The operation at block 401: in response to the Bluetooth activation instruction, in the first state, activating, by the first system, the first Bluetooth application, the first Bluetooth application being configured to support the first service; and activating, by the second system, the second Bluetooth application, the second Bluetooth application being configured to support the second service.

The wearable device further includes the Bluetooth chip. The Bluetooth chip may be mounted on or integrated with the first processor, thereby fully utilizing the low-power characteristic of the first processor. The Bluetooth chip may also be mounted on or integrated with the second processor, thereby fully utilizing the high-performance characteristic of the second processor.

The wearable device may be a smart watch, etc.

The Bluetooth activation instruction may refer to a touch operation instruction received from the user by the wearable device, or may refer to an internal instruction within a system of the wearable device to invoke the Bluetooth functionality.

The wearable device may be in the first state or in the second state.

The wearable device may include three kinds of modes, namely, a standard mode, a high-performance mode and a low power-consumption mode.

Specifically, in the first state, the wearable device operates in the standard mode (also known as the hybrid mode).

The standard mode refers to that, the Bluetooth applications operate on the high-performance processor (the second processor) and the low-performance processor (the first processor) simultaneously. In the standard mode, the first Bluetooth application activated by the first processor may be used to perform the first service (services such as receiving message notifications from a cell phone etc.), while the second Bluetooth application activated by the second processor may be used to perform the second service (services such as a Bluetooth internet access, an application downloading, and OTA updates etc.)

The operation at block 402: in the second state, activating, by the first system, the first Bluetooth application, the first Bluetooth application being configured to support the first service; alternatively, in the second state, activating, by the second system, the third Bluetooth application, the third Bluetooth application being configured to support the first service and the second service.

In the second state, the wearable device operates in the high-performance mode or the low power-consumption mode.

The low power-consumption mode refers to that, the Bluetooth application runs on the low-performance processor (the first processor). In the low power-consumption mode, the first Bluetooth application activated by the first processor may be used for the first service (such as receiving the message notifications from the cell phone, transmitting physiological data, etc.)

The high-performance mode refers to that, the Bluetooth application runs on the high-performance processor (the second processor). In the high-performance mode, the third Bluetooth application activated by the second processor may be used for the first service (such as, receiving the message notifications from the cell phone, transmitting the physiological data, etc.) and the second service (such as, a call forwarding, a Bluetooth internet access, an audio playback, the application downloading, and the OTA updates etc.)

Based on the state of the wearable device, the Bluetooth application may run on the second processor (the high-performance processor), so as to meet the high-performance requirements, the Bluetooth application may also run on the first processor (the low-performance processor), so as to meet the low power-consumption requirements. The Bluetooth application may of course also run simultaneously on both the second processor (the high-performance processor) and the first processor (the low-performance processor) based on specific requirements, so as to fully utilize the high-performance characteristic of the second processor (the high-performance processor) and the low power-consumption characteristic of the first processor (the low-performance processor), thereby providing an enhanced user experience.

In some embodiments of the present disclosure, a Bluetooth sharing scheme based on the dual-system architecture is provided. The second processor (the high-performance processor) and the first processor (the low-performance processor) performs data interaction through calling or invoking a remote procedure call (RPC) apparatus. In this way, a configuration is achieved, in which the Bluetooth applications may be run by the first system or by the second system, or by both the first system and second system, thereby fulfilling the requirements for high performance and low power consumption simultaneously.

The following various embodiments are illustrated through examples in which the Bluetooth chip is mounted on or integrated with the first processor (the low-performance processor).

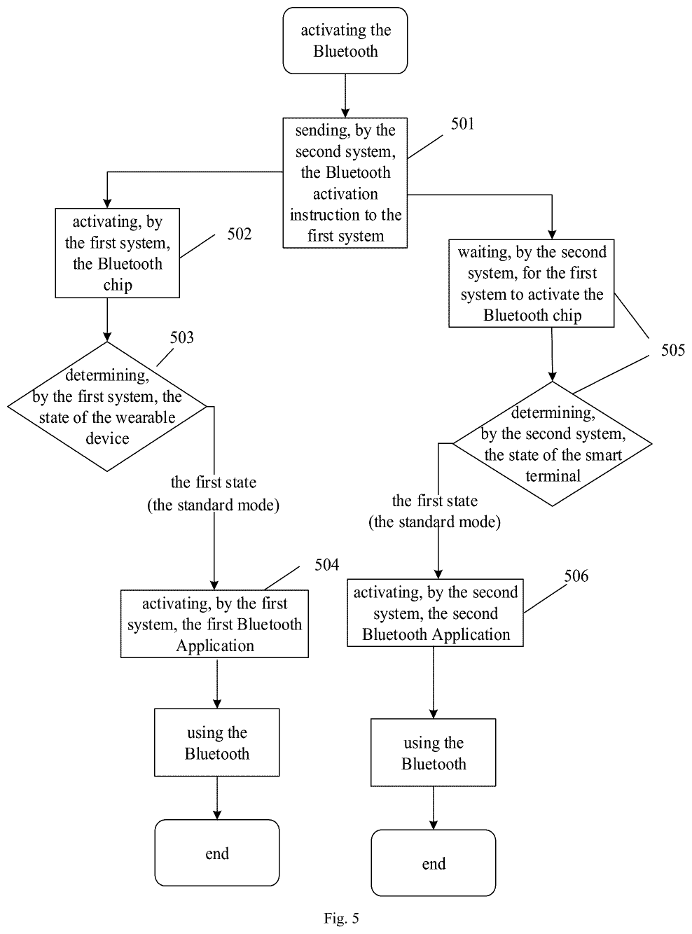

FIG. 5 is a schematic flowchart of a specific implementation of a control method according to an embodiment of the present disclosure. The method includes operations at blocks 501 to 506 as illustrated in FIG. 5.

The operation at block 501: receiving, by the second system, the Bluetooth activation instruction. The Bluetooth activation instruction is configured to indicate an activation of the Bluetooth chip. The second system sends the Bluetooth activation instruction to the first system.

The first system may refer to the operating system running on the first processor (the low-performance processor), such as an RTOS system. The second system may refer to the operating system running on the second processor (the high-performance processor), such as an Android system.

The user may trigger the Bluetooth activation button on a display interface of the wearable device. In this way, the second system may receive the Bluetooth activation instruction.

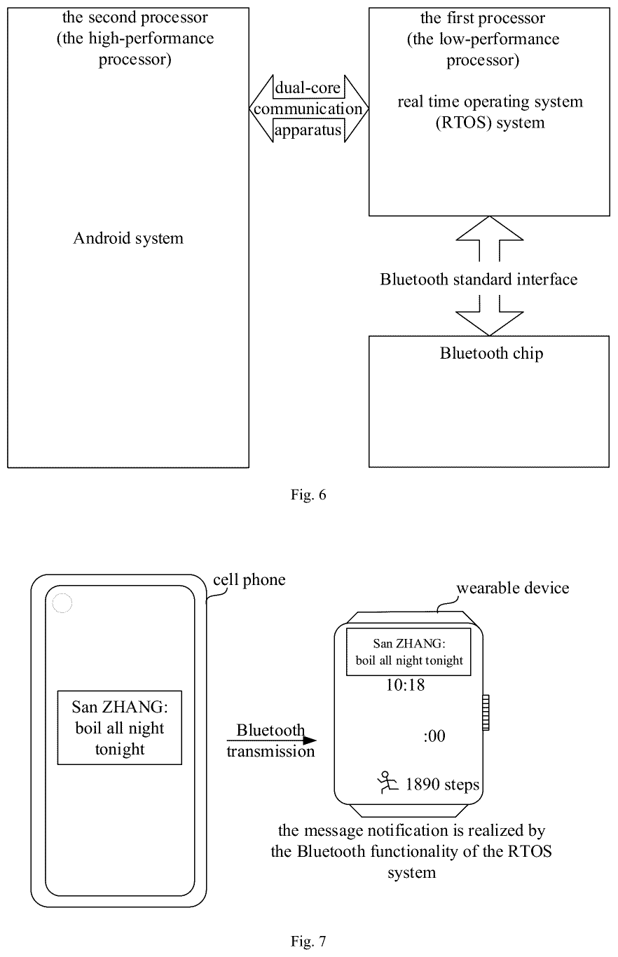

As illustrated in FIG. 6, the second processor (the high-performance processor) may send the Bluetooth activation instruction to the first processor (the low-performance processor) via a “dual-core communication apparatus”.

The operation at block 502: receiving, by the first system, the Bluetooth activation instruction; and activating, by the first system, the Bluetooth chip in response to the Bluetooth activation instruction.

The activating the Bluetooth chip may refer to that, initializing, by the first system, a Bluetooth protocol stack.

The operation at block 503: determining, by the first system, a state of the wearable device; in case the wearable device is in the first state, proceeding to execute the operation at block 504.

In case the wearable device is in the first state, the wearable device may operate in the standard mode.

The operation at block 504: activating, by the first system, the first Bluetooth application.

The activating, by the first system, the first Bluetooth application may refer to that, initializing, by the first system, the first service corresponding to the first Bluetooth application.

After the first Bluetooth application is activated by the first system, the wearable device may perform the first service (such as receiving the message notifications sent from the cell phone) through the first Bluetooth application, and display the received message notifications on the display interface, as illustrated in FIG. 7.

The operation at block 505: waiting, by the second system, for the first system to activate the Bluetooth chip, and determining, by the second system, the state of the wearable device. In case the wearable device is in the first state, proceeding to execute the operation at block 506.

The operation at block 506: activating, by the second system, the second Bluetooth application.

The activating, by the second system, the second Bluetooth application may refer to that, initializing, by the second system, the second service corresponding to the second Bluetooth application.

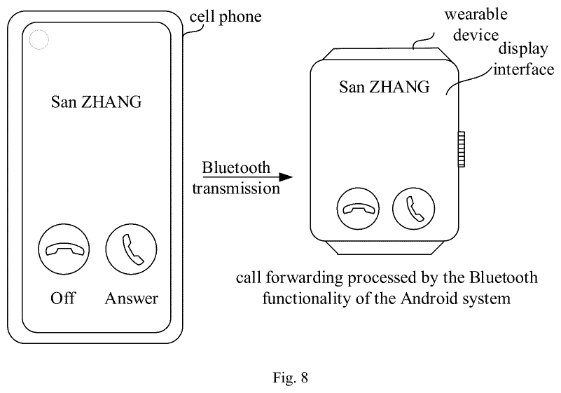

After the second Bluetooth application is activated by the first system, the wearable device may perform the second service (such as the call forwarding) through the second Bluetooth application, and display information such as the forwarded phone number and the user name etc. on the display interface, as illustrated in FIG. 8.

The wearable device may operate in a mode corresponding to the state of the wearable device. If the wearable device operates in the standard mode, the wearable device may fulfill both the high-performance characteristic and the low power-consumption characteristic simultaneously.

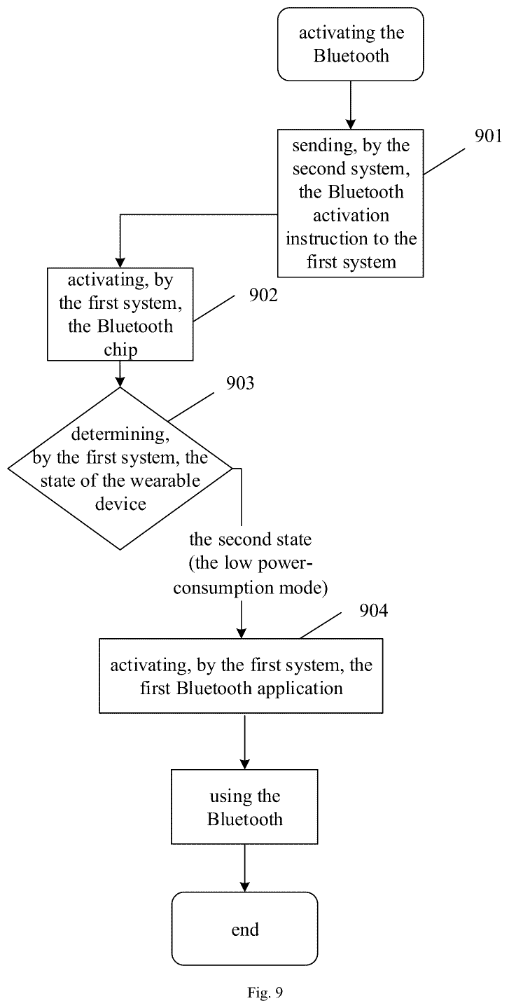

FIG. 9 is a schematic flowchart of a specific implementation of a control method according to an embodiment of the present disclosure. The method includes operations at block 901 to block 904 illustrated in FIG. 9.

The operation at block 901: receiving, by the second system, the Bluetooth activation instruction. The Bluetooth activation instruction is configured to indicate the activation of the Bluetooth chip. The second system sends the Bluetooth activation instruction to the first system.

The operation at block 902: receiving, by the first system, the Bluetooth activation instruction; and activating, by the first system, the Bluetooth chip in response to the Bluetooth activation instruction.

The activating, by the first system, the Bluetooth chip may refer to that, initializing, by the first system, the Bluetooth protocol stack.

The operation at block 903: determining, by the first system, the state of the wearable device; in case the wearable device is in the second state, proceeding to execute the operation at block 904.

In case the wearable device is in the second state, the wearable device may operate in the low power-consumption mode.

The operation at block 904: activating, by the first system, the first Bluetooth application.

The activating, by the first system, the first Bluetooth application may refer to that, initializing, by the first system, the first service corresponding to the first Bluetooth application.

The wearable device may operate in the mode corresponding to the state of the wearable device. If the wearable device operates in the low power-consumption mode, the power consumption experience is optimized.

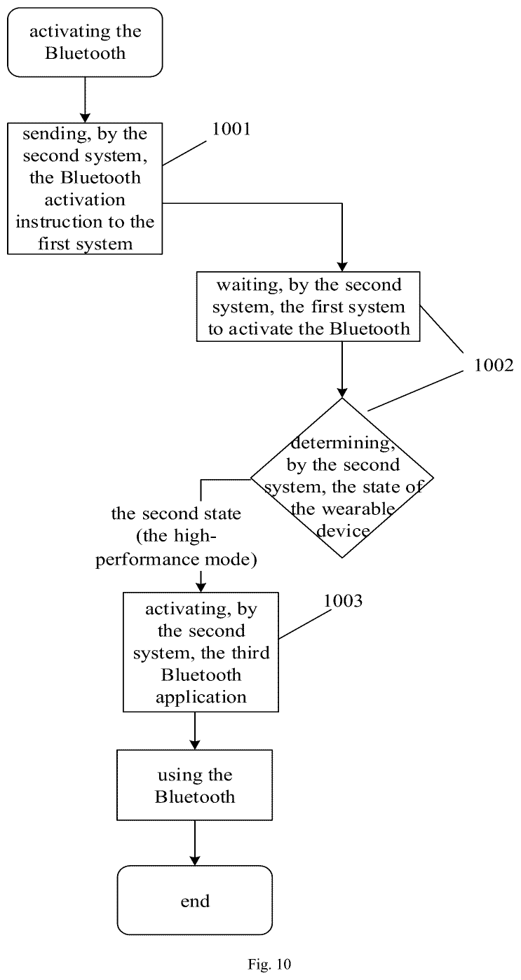

FIG. 10 is a schematic flowchart of a specific implementation of a control method according to an embodiment of the present disclosure. The method includes operations at block 1001 to block 1003 illustrated in FIG. 10.

The operation at block 1001: receiving, by the second system, the Bluetooth activation instruction, the Bluetooth activation instruction being configured to indicate the activation of the Bluetooth chip; sending, by the second system, the Bluetooth activation instruction to the first system.

The operation at block 1002: receiving, by the first system, the Bluetooth activation instruction; and activating, by the first system, the Bluetooth chip in response to the Bluetooth activation instruction. Waiting, by the second system, for the first system to activate the Bluetooth chip, and determining the state of the wearable device. In case the wearable device is in the second state, proceeding to execute the operation at block 1003.

In case the wearable device is in the second state, the wearable device may operate in the high-performance mode.

The operation at block 1003: activating, by the second system, the third Bluetooth application.

The activating, by the second system, the third Bluetooth application may refer to that, initializing, by the second system, the first service and the second service corresponding to the third Bluetooth application.

The wearable device may operate in the mode corresponding to the state of the wearable device. If the wearable device operates in the high-performance mode, the performance experience is optimized.

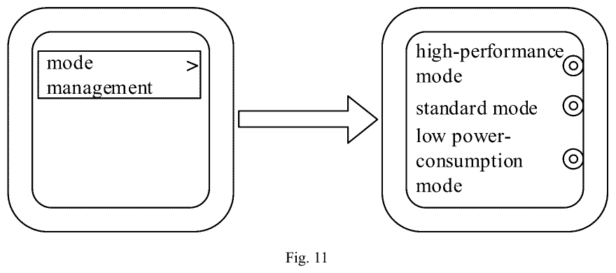

As illustrated in FIG. 11, the user may also select a specified mode in a “mode management” option displayed on the display interface of the wearable device. In this way, in case the wearable device is in the first state, if the first system detects that the current operating mode is the standard mode, the first system activates the first Bluetooth application; if the second system detects that the current operating mode is the standard mode, the second system activates the second Bluetooth application. In case the wearable device is in the second state, if the first system detects that the current operating mode is the low power-consumption mode, the first system activates the first Bluetooth application. In case the wearable device is in the second state, if the second system detects that the current operating mode is the high-performance mode, the second system may activate the third Bluetooth application.

In addition to selecting the specified mode in the “mode management” option displayed on the display interface of the wearable device by the user, “mode selection” switches may also be displayed on the display interface of the wearable device. In this way, after the user touches a switch corresponding to the respective mode, the wearable device may detect the current operating mode.

Specifically, in the second state, the wearable device receives a first instruction, the first instruction is configured to indicate switching to the standard mode. The wearable device switches to the standard mode in response to the first instruction.

Alternatively, in the first state, the wearable device receives a second instruction, the second instruction is configured to indicate switching to the high-performance mode. The wearable device switches to the high-performance mode in response to the second instruction.

Alternatively, in the first state, the wearable device receives a third instruction, the third instruction is configured to indicate switching to the low power-consumption mode. The wearable device switches to the low power-consumption mode in response to the third instruction.

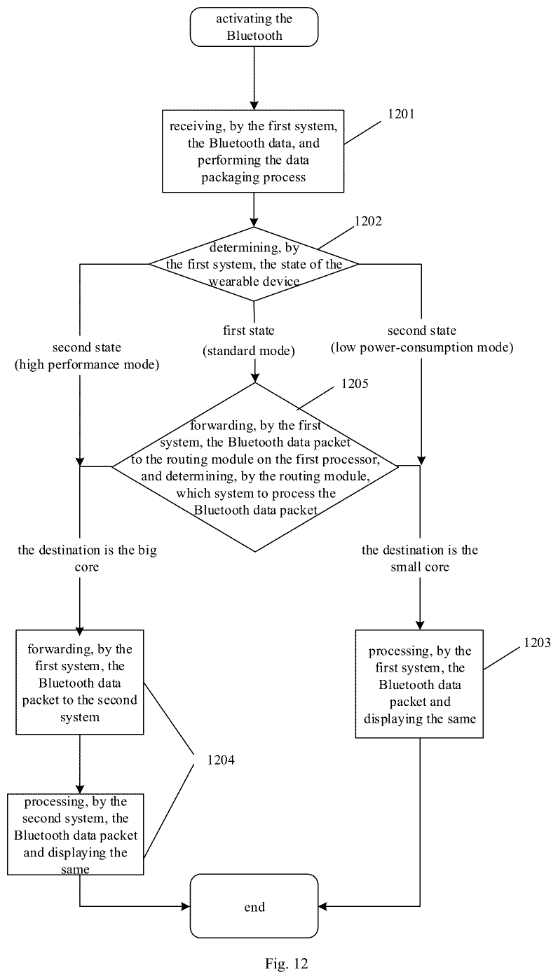

FIG. 12 is an implementing flowchart of a wearable device transmitting and receiving Bluetooth data according to an embodiment of the present disclosure. The method includes operations at block 1201 to block 1205 illustrated in FIG. 12.

The operation at block 1201: receiving, by the first system, the Bluetooth data, and performing a data packaging process.

The first system of the wearable device is responsible for receiving the Bluetooth data through the Bluetooth chip and packaging the Bluetooth data into packets. The Bluetooth data may specifically refer to notification messages etc. sent by a mobile terminal such as a cell phone.

The operation at block 1202: in case the wearable device is in the second state, proceeding to execute the operation at block 1203 or the operation at block 1204; and in case the wearable device is in the first state, proceeding to execute the operation at block 1205.

The operation at block 1203: processing, by the first system, a Bluetooth data packet and displaying the same.

The operation at block 1204: forwarding, by the first system, the Bluetooth data packet to the second system, processing, by the second system, the Bluetooth data packet and displaying the same.

The operation at block 1205: forwarding, by the first system, the Bluetooth data packet to a routing module on the first processor, and determining, by the routing module, which system to process the Bluetooth data packet.

As an implementation embodiment, in case the wearable device is in the first state, the first system forwards the Bluetooth data to the routing module on the first processor. If the routing module determines that the Bluetooth data is data related to the first service, the Bluetooth data would be processed by the first system.

As a second implementation embodiment, in case the wearable device is in the first state, the first system forwards the Bluetooth data to the routing module on the first processor. If the routing module determines that the Bluetooth data is data related to the second service, the Bluetooth data would be processed by the second system.

As a third implementation embodiment, in case the wearable device is in the first state, the first system forwards the Bluetooth data to the routing module on the first processor. In case the first system is in an active state and the second system is in a hibernate state, in response to determining, by the routing module, that the Bluetooth data is data related to the second service, waking up, by the first system, the second system, such that the Bluetooth data is processed by the second system.

In the high-performance mode, only the second system activates the Bluetooth application. In the low power-consumption mode, only the first system activates the Bluetooth application. In this way, after the first processor (the low-performance processor) receives the Bluetooth data through the Bluetooth chip, the first system may determine, based on the operating mode, whether the data packet is intended to be sent to the second system or to be processed by the first system itself.

In the standard mode, both the second system and the first system have activated the Bluetooth application. After the first processor (the low-performance processor) receives the data packet through the Bluetooth chip, the first system cannot determine, solely based on the operating mode, whether the data packet is intended to be sent do the second system or to be processed by the first system itself. Therefore, it is necessary to introduce a software module named the “routing module” onto the first processor. This software module would determine whether the system configured to process the Bluetooth data is the first system or the second system.

When sending the Bluetooth data to the terminal device such as the cell phone, the first processor sends the Bluetooth data through the Bluetooth chip. The second processor sends the Bluetooth data to be sent to the first processor for the first processor to send the Bluetooth data.

In the technical scheme of the present disclosure, the wearable device includes a dual-system Bluetooth functionality and may determine, based on the current state of the wearable device, whether the first system runs the Bluetooth application or the second system runs the Bluetooth application. Alternatively, both the first processor and the second processor run the Bluetooth application. Therefore, the wearable device may provide a high-performance and low power-consumption experience based on actual conditions.

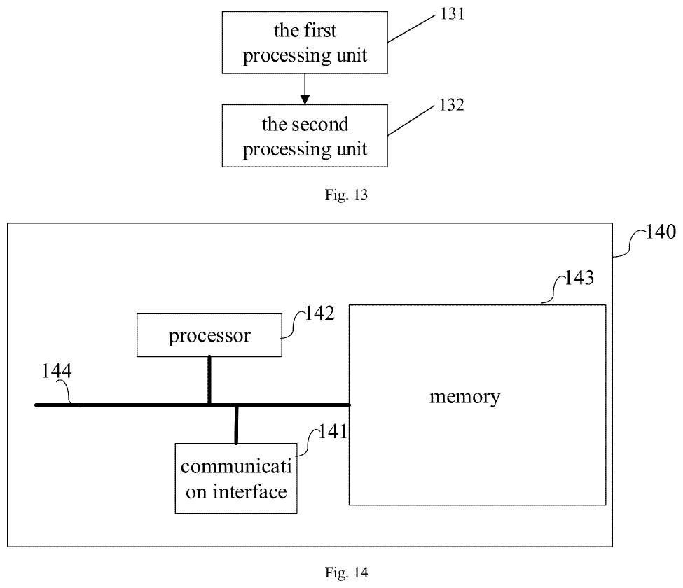

To implement the control method of the present disclosure, the present disclosure further provides a control apparatus. The control apparatus is configured on the wearable device. The wearable device includes the first processor and the second processor. The first processor is configured to run the first system. The second processor is configured to run the second system. FIG. 13 is a schematic diagram of a compositional structure of the control apparatus according to an embodiment of the present disclosure. As illustrated in FIG. 13, the control apparatus may include: a first processing unit 131 and a second processing unit 132.

The first processing unit 131 is configured to: in response to the Bluetooth activation instruction, in the first state, activate the first Bluetooth application, the first Bluetooth application being configured to support the first service; and activate the second Bluetooth application, the second Bluetooth application being configured to support the second service.

The second processing unit 132 is configured to: in the second state, activate the first Bluetooth application, the first Bluetooth application being configured to support the first service; or, in the second state, activate the third Bluetooth application, the third Bluetooth application being configured to support the first service and the second service.

In some embodiments, the second processing unit 132 is further configured to: receive the Bluetooth activation instruction; the Bluetooth activation instruction being configured to indicate the activation of the Bluetooth chip; and send the Bluetooth activation instruction to the first processing unit 131. The first processing unit 131 is further configured to: receive the Bluetooth activation instruction; activate the Bluetooth chip in response to the Bluetooth activation instruction.

In some embodiments, the first processing unit 131 is further configured to: receive the Bluetooth data; and process the Bluetooth data based on a current state.

In some embodiments, the first processing unit 131 is specifically configured to: in case the wearable device is in the second state, process the Bluetooth data; or, in case the wearable device is in the second state, forward the Bluetooth data to the second processing unit 132, such that the Bluetooth data is processed by the second processing unit 132; or, in case the wearable device is in the first state, forward the Bluetooth data to the routing module on the first processor, and the routing module determines which system to process the Bluetooth data.

In some embodiments, the routing module is configured to: in case the Bluetooth data is the data related to the first service, send the Bluetooth data to the first processing unit 131, and process, by the first processing unit 131, the Bluetooth data; in case the Bluetooth data is the data related to the second service, send the Bluetooth data to the second processing unit 132, and process, by the second processing unit 132, the Bluetooth data.

The routing module is specifically configured to: in case the first system is in the active state and the second system is in the hibernate state, in response to determining that the Bluetooth data is the data related to the second service, wake up, by the first system, the second system, and process, by the second system, the Bluetooth data.

In some embodiments, the wearable device includes the standard mode, the high-performance mode and the low power-consumption mode.

In the first state, the wearable device operates in the standard mode. In the second state, the wearable device operates in the high-performance mode or the low power-consumption mode.

The in the first state, the wearable device operates in the standard mode includes: in the second state, receiving, by the wearable device, the first instruction; the first instruction being configured to indicate switching to the standard mode; and the wearable device switching to the standard mode in response to the first instruction.

The in the second state, the wearable device operates in the high-performance mode or the low power-consumption mode includes: in the first state, receiving, by the wearable device, the second instruction, the second instruction being configured to indicate switching to the high-performance mode, the wearable device switching to the high-performance mode in response to the second instruction; or, in the first state, receiving, by the wearable device, the third instruction, the third instruction being configured to indicate switching to the low power-consumption mode, the wearable device switching to the low power-consumption mode in response to the third instruction.

In some embodiments, the performance level requirement of the second processor is higher than that of the first processor, the power-consumption level requirement of the first processor is higher than that of the second processor.

In actual applications, the first processing unit 131, the second processing unit 132 and the routing module may be implemented by the processors in the apparatus. The processors may be central processing units (CPU), digital signal processors (DSP), microcontroller units (MCU), or field-programmable gate arrays (FPGA).

When the apparatus provided in the above-mentioned embodiments is performing a control process, the division of each of the above-mentioned program modules is only taken as an example for illustration. In actual applications, the above-mentioned processing may be assigned to and implemented by different program modules per requirements. In other words, the internal structure of the terminal device may be divided into different program modules, so as to complete the above-described processing in whole or in part. In addition, the apparatus provided by the above-mentioned embodiments belongs to a same concept as the control method embodiment. The specific implementing process of the terminal device is detailed in the method embodiments, which will not be elaborated herein.

Based on the hardware implementation of the above-mentioned device, the present disclosure further provides an electronic device. FIG. 14 is a schematic structural diagram illustrating the hardware composition of the terminal device according to an embodiment of the present disclosure. As illustrated in FIG. 14, the electronic device 140 includes a memory 143, a processor 142 and a computer program. The computer program is configured to be stored on the memory 143 and executed by the processor 142. The processor 142, when executing the program, implements the method provided in the above-mentioned one or more technical schemes.

The specific operations implemented when the processor 142 executes the computer program have been detailed above, and will not be elaborated herein.

The electronic device 140 further includes a communication interface 141. The communication interface 141 is configured to perform information interaction with other devices. Meanwhile, various components of the electronic device 140 are coupled together through a bus system 144. The bus system 144 may be configured to enable connection and communication between these components. In addition to a data bus, the bus system 144 may further include a power bus, a control bus and a status signal bus etc.

The memory 143 in the present embodiment may be a volatile memory or a non-volatile memory. The memory may include both the volatile memory and the non-volatile memory. The non-volatile memory may be a read only memory (ROM), a programmable read-only memory (PROM), an erasable programmable read-only memory (EPROM), an electrically erasable programmable read-only memory (EEPROM), a ferromagnetic random-access memory (FRAM), a flash memory, a magnetic surface memory, an optical disk or a compact disc read-only memory (CD-ROM). The magnetic surface memory may be a magnetic disk memory or a magnetic tape memory. The volatile memory may be a random-access memory (RAM), and is used as an external high-speed cache. By way of exemplary but not as a limiting illustration, many types of RAMs are available. The RAM may be a static random-access memory (SRAM), a synchronous static random-access memory (SSRAM), a dynamic random access memory (DRAM), a synchronous dynamic random access memory (SDRAM), a double data rate synchronous dynamic random access memory (DDRSDRAM), an enhanced synchronous dynamic random access memory (ESDRAM), a sync link dynamic random access memory (SLDRAM) and a direct rambus random access memory (DRRAM). The memory described in embodiments of the present disclosure is intended to include, but is not limited to, these and any other suitable types of memories.

The method disclosed in the above-mentioned embodiments of the present disclosure may be applied to the processor 142, or may be implemented by the processor 142. The processor 142 may be an integrated circuit chip with signal processing capability. During implementation, various operations of the above-mentioned method may be accomplished by an integrated logic circuitry in hardware-form or instructions in software-form in the processor 142. The above-mentioned processor 142 may be a general-purpose processor, a DSP, or another programmable logic device, a discrete gate or a transistor logic device, a discrete hardware component etc. The processor 142 may realize or perform the various methods, operations, and logic block diagrams disclosed in the embodiments of the present disclosure. The general-purpose processor may be a micro-processor or any conventional processor, etc. The operations of methods disclosed in conjunction with the embodiments of the present disclosure may be performed directly by the hardware decoding processor, or by a combination of hardware and software modules in the decoding processor. The software module may be arranged in a storage medium. The storage medium may be arranged in the memory. The processor 142 may read the information from the memory, and complete the operations of the above-mentioned method in conjunction with the hardware of the processor 142.

The present disclosure further provides the storage medium. The storage medium is specifically a computer storage medium, and more particularly a computer-readable storage medium. The storage medium stores a computer instruction, i.e., the computer program. The computer instruction, when being executed by the processor, implements the method provided in the above-mentioned one or more technical schemes.

In the several embodiments provided in the present disclosure, the disclosed methods and smart devices may be implemented in other ways. The device embodiments described above are merely illustrative. For example, the division of units is only a logical function division, and there may be other division manners in actual implementations. For example, multiple units or components may be combined or integrated into another system, or some features may be ignored or not implemented. In addition, the couplings, direct couplings or communication connections between the components illustrated or discussed may be indirect couplings or communication connections through some interfaces, devices or units, and may be electrical, mechanical or of other forms.

The units illustrated as separate components may or may not be physically separate, and the components illustrated as units may or may not be physical units. The units may be in one place, or may be distributed on multiple network units. Some or all the units may be selected per actual needs to fulfill the aim of the implementation of the present embodiment.

In addition, the various functional units in the embodiments of the present disclosure may all be integrated into a processing unit, or each unit may be individually used as a unit, or two or more units may be integrated into one unit. The above-mentioned integrated units may be realized in the form of hardware, or in the form of hardware plus software functional units.

Those of ordinary skills in the art may understand that, all or a part of the operations of the above method embodiments may be implemented by a hardware relating to a program instruction. The afore-mentioned program may be stored in the computer-readable storage medium. The program, when being executed, implements the operations including the method embodiments described above. The afore-mentioned storage medium may include: a removable storage device, an ROM, an RAM, a magnetic disk or a CD and other mediums that are capable of storing program instructions.

Alternatively, in the present disclosure, if the above-mentioned integrated unit is implemented in the form of a software function module and sold or used as an independent product, it may also be stored in a computer readable storage medium. Based on such kind of appreciation, the technical schemes of embodiments of the present disclosure essentially or a part of it contributing to the related art may be embodied in the form of a software product. The computer software product may be stored in one storage medium. The computer software product may include several instructions which may enable a computer device (which may be a personal computer, a terminal device or a network device etc.) to implement all or a part of the operations of the method according to the various embodiments of the present disclosure. The afore-mentioned storage medium may include: a removable storage device, an ROM, an RAM, a magnetic disk or a CD and other mediums that could store program instructions.

The terms “first”, “second” and the like are used for distinguishing between similar items and not necessarily for describing a particular sequential or chronological order.

In addition, the technical schemes described in embodiments of the present disclosure may be combined arbitrarily without causing conflict.

The above are only specific implementations of the present disclosure, and the protection scope of the present disclosure is not limited thereto. Changes or alternations within the technical scope of the present disclosure could easily occur to those skilled in the art and should be in the protection scope of the present disclosure.

1. A control method performed by a wearable device, the wearable device comprising a first system and a second system, and the method comprising:
in response to a Bluetooth activation instruction, in a first state, activating, by the first system, a first Bluetooth application, the first Bluetooth application being configured to support a first service; activating, by the second system, a second Bluetooth application, the second Bluetooth application being configured to support a second service; and/or
in a second state, activating, by the first system, the first Bluetooth application, the first Bluetooth application being configured to support the first service; or, in the second state, activating, by the second system, a third Bluetooth application, the third Bluetooth application being configured to support the first service and the second service.

2. The method as claimed in claim 1, wherein
the in response to the Bluetooth activation instruction comprises:
receiving, by the second system, the Bluetooth activation instruction, and sending the Bluetooth activation instruction to the first system; and
receiving, by the first system, the Bluetooth activation instruction; initializing, by the first system, a Bluetooth protocol stack.

3. The method as claimed in claim 1, further comprising:
receiving, by the first system, Bluetooth data; and
processing the Bluetooth data based on a current state.

4. The method as claimed in claim 3, wherein
the processing the Bluetooth data based on the current state comprises:
in case the wearable device is in the second state, processing, by the first system, the Bluetooth data; or
in case the wearable device is in the second state, forwarding, by the first system, the Bluetooth data to the second system, processing, by the second system, the Bluetooth data; or
in case the wearable device is in the first state, forwarding, by the first system, the Bluetooth data to a routing module on a first processor of the wearable device, determining, by the routing module, which system to process the Bluetooth data,
wherein the first processor is configured to run the first system.

5. The method as claimed in claim 4, wherein
the determining, by the routing module, which system to process the Bluetooth data comprises:
in case the Bluetooth data is data related to the first service, sending the Bluetooth data to the first system; and
in case the Bluetooth data is data related to the second service, sending the Bluetooth data to the second system.

6. The method as claimed in claim 5, further comprising:
in case the first system is in an active state and the second system is in a hibernate state, in response to determining, by the routing module, that the Bluetooth data is the data related to the second service, waking up, by the first system, the second system, and processing, by the second system, the Bluetooth data.

7. The method as claimed in claim 1, wherein
the wearable device comprises one or more selected from the group consisting of a standard mode, a high-performance mode and a low power-consumption mode;
in the first state, the wearable device operates in the standard mode; and/or
in the second state, the wearable device operates in the high-performance mode or the low power-consumption mode.

8. The method as claimed in claim 7, wherein
the in the first state, the wearable device operates in the standard mode comprises:
in the second state, receiving, by the wearable device, a first instruction; the first instruction being configured to indicate switching to the standard mode; the wearable device switching to the standard mode in response to the first instruction; and/or
the in the second state, the wearable device operates in the high-performance mode or the low power-consumption mode comprises:
in the first state, receiving, by the wearable device, a second instruction; the second instruction being configured to indicate switching to the high-performance mode; the wearable device switching to the high-performance mode in response to the second instruction; or
in the first state, receiving, by the wearable device, a third instruction; the third instruction being configured to indicate switching to the low power-consumption mode; the wearable device switching to the low power-consumption mode in response to the third instruction.

9. The method as claimed in claim 1, wherein
the wearable device comprises a first processor and a second processor, the first processor is configured to run the first system, the second processor is configured to run the second system,
a performance level requirement of the second processor is higher than that of the first processor, a power-consumption level requirement of the first processor is higher than that of the second processor.

10. (canceled)

11. An electronic device, comprising a processor and a memory, the memory being configured to store a computer program that is capable of running on the processor, the electronic device comprising a first system and a second system, wherein
the processor is configured to, while running the computer program, implement operations of a control method, the control method comprises:
in response to a Bluetooth activation instruction, in a first state, activating, by the first system, a first Bluetooth application, the first Bluetooth application being configured to support a first service; activating, by the second system, a second Bluetooth application, the second Bluetooth application being configured to support a second service; and/or
in a second state, activating, by the first system, the first Bluetooth application, the first Bluetooth application being configured to support the first service; or, in the second state, activating, by the second system, a third Bluetooth application, the third Bluetooth application being configured to support the first service and the second service.

12. A non-transitory computer-readable storage medium storing a computer program, wherein
the computer program, when being executed by a processor of a wearable device, is configured to implement operations of a control method,
the electronic device comprises a first system and a second system, and the method comprises:
in response to a Bluetooth activation instruction, in a first state, activating, by the first system, a first Bluetooth application, the first Bluetooth application being configured to support a first service; activating, by the second system, a second Bluetooth application, the second Bluetooth application being configured to support a second service; and/or
in a second state, activating, by the first system, the first Bluetooth application, the first Bluetooth application being configured to support the first service; or, in the second state, activating, by the second system, a third Bluetooth application, the third Bluetooth application being configured to support the first service and the second service.

13. The electronic device as claimed in claim 11, wherein
the in response to the Bluetooth activation instruction comprises:
receiving, by the second system, the Bluetooth activation instruction, and sending the Bluetooth activation instruction to the first system; and
receiving, by the first system, the Bluetooth activation instruction; initializing, by the first system, a Bluetooth protocol stack.

14. The electronic device as claimed in claim 11, the method further comprising:
receiving, by the first system, Bluetooth data; and
processing the Bluetooth data based on a current state, comprises:
in case the wearable device is in the second state, processing, by the first system, the Bluetooth data; or
in case the wearable device is in the second state, forwarding, by the first system, the Bluetooth data to the second system, processing, by the second system, the Bluetooth data; or
in case the wearable device is in the first state, forwarding, by the first system, the Bluetooth data to a routing module on a first processor of the wearable device, determining, by the routing module, which system to process the Bluetooth data,
wherein the first processor is configured to run the first system.

15. The electronic device as claimed in claim 14, wherein
the determining, by the routing module, which system to process the Bluetooth data comprises:
in case the Bluetooth data is data related to the first service, sending the Bluetooth data to the first system; and
in case the Bluetooth data is data related to the second service, sending the Bluetooth data to the second system.

16. The electronic device as claimed in claim 15, the method further comprising:
in case the first system is in an active state and the second system is in a hibernate state, in response to determining, by the routing module, that the Bluetooth data is the data related to the second service, waking up, by the first system, the second system, and processing, by the second system, the Bluetooth data.

17. The electronic device as claimed in claim 11, wherein
the wearable device comprises one or more selected from the group consisting a standard mode, a high-performance mode and a low power-consumption mode;
in the first state, the wearable device operates in the standard mode; and/or
in the second state, the wearable device operates in the high-performance mode or the low power-consumption mode.

18. The storage medium as claimed in claim 12, wherein
the in response to the Bluetooth activation instruction comprises:
receiving, by the second system, the Bluetooth activation instruction, and sending the Bluetooth activation instruction to the first system, the Bluetooth activation instruction being configured to indicate an activation of a Bluetooth chip; and/or
receiving, by the first system, the Bluetooth activation instruction; activating, in response to the Bluetooth activation instruction, the Bluetooth chip.

19. The storage medium as claimed in claim 12, the method further comprising:
receiving, by the first system, Bluetooth data; and
processing the Bluetooth data based on a current state, comprises:
in case the wearable device is in the second state, processing, by the first system, the Bluetooth data; or
in case the wearable device is in the second state, forwarding, by the first system, the Bluetooth data to the second system, processing, by the second system, the Bluetooth data; or
in case the wearable device is in the first state, forwarding, by the first system, the Bluetooth data to a routing module on a first processor, determining, by the routing module, which system to process the Bluetooth data,
wherein the first processor is configured to run the first system.

20. The storage medium as claimed in claim 19, wherein
the determining, by the routing module, which system to process the Bluetooth data comprises:
in case the Bluetooth data is data related to the first service, sending the Bluetooth data to the first system; and
in case the Bluetooth data is data related to the second service, sending the Bluetooth data to the second system.

21. The storage medium as claimed in claim 20, the method further comprising:
in case that the first system is in an active state and the second system is in a hibernate state, in response to determining, by the routing module, that the Bluetooth data is the data related to the second service, waking up, by the first system, the second system, and processing, by the second system, the Bluetooth data.
